(19) United States
(12) Patent Application Publication
(10) Pub. No.: US 2021/0392915 A1
(43) Pub. Date: Dec. 23, 2021

(54) PLANT-BASED CHOCOLATE WITH SESAME COMPONENT AND METHOD FOR MAKING SAME

(71) Applicant: Nina Leona Delon, Arlington, VA (US)

(72) Inventor: Nina Leona Delon, Arlington, VA (US)

(21) Appl. No.: 17/192,885

(22) Filed: Mar. 5, 2021

Related U.S. Application Data
(60) Provisional application No. 63/041,917, filed on Jun. 21, 2020.

(51) Int. Cl. A23G 1/48; A23G 1/00

(52) U.S. Cl. CPC A23G 1/48; A23L 29/10; A23G 1/0066

(57) ABSTRACT

A plant-based chocolate comprising a sesame component and a cacao component. Other components added include a sweetening component, cacao powder and a flavor component to produce a plant-based chocolate at a desirable polymorphic state, a smooth mouth feel, and a melting point right below body temperature. The components are subject to a forming step that results in partial crystallization, followed by a tempering step to achieve the desired polymorphic state. Formulations provide for gourmet plant-based chocolate, closely resembling and improving the sensory and physical attributes of premium dairy-based milk and white chocolate, without the need to incorporate allergens like tree-nut milks or butters, soy or gluten.

### CROSS-REFERENCE TO RELATED APPLICATIONS

This application claims the benefit of U.S. Provisional Application No. 63/041,917, filed on Jun. 21, 2020, the contents of which are hereby incorporated by reference.

### REFERENCES CITED

### US Patent Documents

U.S. Pat. No. 10,021,893 July, 2018 Heine

### Other References

Veronika Bari\grave{s}ic et al., The Chemistry behind Chocolate Production, 2019.
B. Liang et al., Effects of Milk Powders in Milk Chocolate, 2004.

### TECHNICAL FIELD

The present disclosure relates generally to a plant-based chocolate with a sesame component resembling dairy-based white and milk chocolate in flavor, aroma and physical properties and a method for making same.

### BACKGROUND

The global chocolate market size was valued at USD 130.56 billion in 2019 and is expected to grow at a compound annual growth rate of 4.6% from 2020 to 2027. Rising awareness regarding dark chocolate as a healthier confectionery product, which contains more than triple the amounts of antioxidants than milk and white chocolate, is expected to promote the market growth over the next few years. However, milk chocolate is the dominant variant among various traditional chocolates.

In general, the plant-based food industry has experienced growth of over 20 percent in dollar sales over last Two years. The global vegan confectionary market size was valued at USD 816.0 million in 2019 and is expected to grow at a compound annual rate of 11.8% from 2021 to 2027.

Many individuals including health-conscious eaters, vegans and people with food allergies, all look for a chocolate treat that suits their nutritional needs.

The FDA classifies Dairy-based Milk and white chocolate as containing at least 15.5% (w/w) milk compounds. During cocoa butter crystallization the presence of milk fat increases the induction time for crystallization, delay it and generates the formation of less stable polymorphic forms (β′ forms).

Also, Chocolate has different viscosities at different shear rates. As such, measuring single-shear rate viscosity once or twice throughout the entire chocolate-making process does not provide sufficient information to predict—and, then, control—the chocolate's flow performance, which causes chocolate manufacturers to use industrial emulsifiers in their confectionaries. A trend not so popular among healthy-eating enthusiasts.

So far, a process is lacking to make premium gourmet plant-based chocolate that actually resembles dairy based milk and white chocolate in flavor, aroma and sensory attributes, maintains freshness, taste, and shape in a variety of temperature and conditions without fat bloom or sugar bloom, or other forms of deformation, and without using preservatives.

There have been several attempts to replace dairy-milk with coconut milk, almond milk, soy milk, nut butters as well as rice powder and rice syrup in making gourmet chocolate, but the characteristics of the used milks, their adverse effects on cacao butter crystallization as well as their overpowering flavors hinders those efforts. The available plant-based chocolate products are industrialized for the most part, vs. gourmet. Further, those mentioned plant-based alternatives are responsible for 90% of food allergies.

U.S. Pat. No. 10,021,893 describes a chocolate food product comprising a cocoa butter, an unsweetened cocoa powder, a glycerin, a coconut cream, an almond milk, a pectin, a salt, a monk fruit blend, and a coconut flour with a melting point higher than 120.degrees.F. However, coconut and almond milk are among the main food allergens; moreover, the high glycerin and pectin content make the product less desirable by health-conscious eaters actively looking for natural ingredients. The resulting chocolate product is considered an industrial chocolate rather than a gourmet chocolate given its composition, texture and high melting point.

It would therefore be advantageous to provide a solution that would overcome the challenges noted above.

### SUMMARY

The inventor of the present invention have found that using a sesame component of specific macronutrient composition and specific range of bulk density to replace milk in traditional dairy-based milk and white chocolate, could surprisingly result in gourmet plant-based chocolate, closely resembling and even improving flavor, aroma and other physical and sensory attributes of premium dairy-based milk and white chocolate at a desired polymorphic state V.

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a plant-based chocolate resembling white and milk dairy-based chocolates sensory and physical profiles. The plant-based chocolate comprises a sesame component, the sesame component including sesame flour, sesame protein, hulled sesame paste (also referred to later by “sesame paste”), or any combination thereof.

Certain embodiments disclosed herein also include a method for making and tempering chocolate comprising a sesame component to a desired Polymorphic state. The method includes warming a cacao component until completely melted, supercooling the cacao component by gradually mixing in solid compounds of a sesame component or an admixture of solid compounds of a sesame component and other solids like sugar, cacao powder and/or vanilla beans. Placing the combination with the sesame component in a mold, cooling the combination until it hardens, re-heating the hardened combination until melted, then supercooling the combination. Placing the combination with the sesame component in a mold, re-cooling the combination.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 depicts a flow chart of one embodiment for forming and tempering a plant-based chocolate comprising a sesame component to a desired polymorphic form.

### DETAILED DESCRIPTION

Because of the homogeneity in triacylglycerols TAG composition and conformation, polymorphism in cocoa butter is complex. Cocoa butter can crystalize in 6 different forms. Form V is considered the optimal polymorph by the confectionery industry, since it provides the desired sensory properties of chocolate. However, the introduction of other components to chocolate can dramatically influence its crystallization and thus the final chocolate product characteristics, such as mouthfeel, snap, gloss and melting point. This has particularly hindered the efforts to create gourmet plant-based milk and white chocolate alternatives, despite the growing trend and demand for vegan and dairy-free products. In addition, taste and flavor are often overpowered by strong notes specific to the plant of origin, making masking of undesirable flavor difficult. Using the plant-based chocolate composition and methods described herein, the inventor was able to produce gourmet plant-based chocolate at polymorphic form V that closely resembles and improves dairy-based milk and white chocolate in flavor, texture and other physical and sensory properties. Further, other plant-based chocolate confectionaries can be created using a sesame component like chocolate ganache and other traditional confectionaries calling for the use of milk or milk powder.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. The terms “including,” “comprising,” “having,” “characterized by” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified together with the phrase.

As used herein, “nutritive sweetener” refers generally to a sweetener that provides significant caloric content in typical usage amounts, e.g., more than about 5 calories per 8 oz. serving of a chocolate product. The term “non-nutritive sweetener” refers to a sweetener other than a nutritive sweetener.

As used herein, “polymorph”, “polymorphic state”, “polymorphic form” and variations thereof refer to one of at least 6 different structures or ‘crystal forms’ of chocolate that differ in how molecules are arranged, which in turn influences their properties, such as appearance, texture, and melting point.

As used herein, “supercooling” refers to gradually cooling a component by increments between 0.5 to 5 degrees/min.

The term “crème blanche chocolate” refers to a plant-based chocolate comprising a sesame component, that is an equivalent to a dairy-based white chocolate, without incorporating dairy or plant-based milk.

The term “crème gold chocolate” refers to a plant-based chocolate comprising a sesame component that is an equivalent to a dairy-based milk chocolate, without incorporating dairy or plant-based milk.

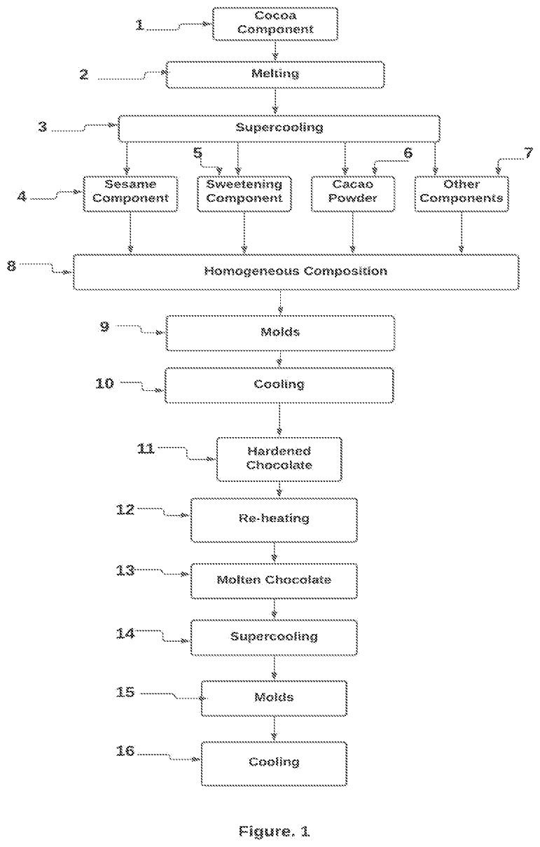

A method for making a plant-based chocolate comprising a sesame component described herein will now be described with reference to FIG. 1. In the preparation of the plant-based chocolate to undergo tempering to produce a gourmet plant-based chocolate at a desired polymorphic state, a cacao component 1 is completely melted 2 at a controlled temperature. In some embodiments, the melting step 2 comprises heating the cacao component using indirect heat, for example a zone created adjacent to a heat source. In some embodiments, the melting step 2 comprises heating the cacao component at temperatures between 100.degrees.F. to 120.degrees.F.

In some embodiments, the cacao component 1 comprises cacao butter. In some embodiments, the cacao component 1 comprises cacao liquor. In some embodiments, the cacao component 1 comprises an admixture of cacao butter and cacao liquor. The cacao component average percent weight to overall product weight can vary based on desired Polymorph and finished product physical and sensory attributes, as well as percent weight of dry components, fats, oils, liquids or any combination thereof introduced to the product at the forming or tempering phase. In some embodiments, the cacao component is between about 10% to about 90%. In some embodiments, the cacao component is about 10%. In some embodiments, the cacao component is about 45%. In some embodiments, the cacao component is about 55%. As a non-limiting example, a gourmet plant-based “crème blanche” or “crème gold chocolate” with a sesame component comprises about 44% of a cacao component. In another non-limiting example, a “crème gold” chocolate ganache comprises about 15% of a cacao component. All percentages in this paragraph refer to cacao component percent weight to overall product weight.

Referring back to FIG. 1, once the cacao component 1 is completely melted 2 it is then supercooled 3 to allow for partial nucleation to take place by gradually mixing in a sesame component 4 until a homogeneous composition 8 is created. In some embodiments, the sesame component 4 is gradually mixed in until a homogeneous composition is created at temperatures between about 93.degrees.F. to about 100.degrees.F. In some embodiments, the supercooling step 3 occurs at increments between about 0.5 to about 2 degrees per minute.

In some embodiments, the sesame component 4 characterized by a Macronutrient composition of having average protein to fat ratio of about 3:2 by weight. In some embodiments, the sesame component 4 characterized by a Macronutrient composition of having average protein to fat ratio of about 2:4 by weight. In some embodiments, the sesame component comprises sesame flour, sesame protein, hulled sesame paste, or any combination thereof. Suitable forms of sesame flour, sesame protein and hulled sesame paste are readily available from any number of manufacturers.

In some embodiments, the bulk density of the solid part of the sesame component is between about 0.1 g/ml to about 0.3 g/ml, ideally 0.17±0.03 g/ml. In some embodiments, the solid part of a sesame component is mixed after the melting step 2 of the cacao component 1. In some embodiments, the liquid part of the sesame component (i.e. sesame paste) is mixed after the homogeneous composition 8 reaches a temperature between about 93.degrees.F. to about 100.degrees.F. In some embodiments, the sesame component comprising between about 5% to about 80%. The sesame component average percent weight to overall product weight can vary based on desired Polymorph and finished product physical and sensory attributes, as well as percent weight of other dry components, fats, oils, liquids, or any combination thereof introduced to the product at the forming or tempering phases. Thus, the oral and sensory interaction between the sesame component and other components can involve the interrelationship of elements. In some embodiments, the sesame component comprises about 8%. In some embodiments, the sesame component comprises about 18%. In some embodiments, the sesame component comprises about 40%. All percentages in this paragraph refer to sesame component percent weight to overall product weight.

Referring back to FIG. 1, in some embodiments, once the sesame component 4 is mixed, a sweetening component 5 comprising one or more sweeteners may also be mixed with the homogeneous composition 8. Components then undergo mixing to form the homogeneous composition 8.

The sweetening component 5 can be nutritive or non-nutritive, natural or synthetic sweetener, or a combination of such sweeteners, so long as the sweetener(s) provides a taste that is perceived as sweet by the sense of taste. The sweeteners included in the plant-based chocolate disclosed herein are edible consumables. The percent weight of the sweetening agents can depend to some extent on the interrelation of elements. The sweetening component average percent weight to overall product weight can vary based on desired oral attributes, as well as percent weight of other components in the homogeneous composition. In certain embodiments, one or more nutritive sweeteners can be present in the plant-based chocolate in an amount between about 5% to about 55% by weight of overall product weight. In some embodiments, one or more nutritive sweeteners can be present in the plant-based chocolate in an amount comprising 35% by weight of overall product weight.

In some embodiments, the sweetening component comprises a nutritive sweetener. In some embodiments, the sweetening component comprises a non-nutritive sweetener. In some embodiments, the sweetening component comprises a nutritive sweetener and a non-nutritive sweetener. In some embodiments, the sweetening component comprises a combination of one or more natural nutritive sweeteners, one or more artificial sweeteners, and/or one or more natural non-nutritive sweeteners. Suitable forms of non-nutritive and nutritive sweeteners are readily available from any number of manufacturers.

In some embodiments, the nutritive sweetener is sucrose, glucose, fructose, or any combination thereof. In some embodiments, the nutritive sweetener is high fructose corn syrup (HFCS), honey granules, maple syrup, agave nectar, coconut nectar or sugar. By way of example, the term “sugar” includes natural cane sugar made from sugar cane and/or granulated sugar made from either cane or sugar beets.

In some embodiments, the non-nutritive sweetener is a natural non-nutritive sweetener selected from the group consisting of rebaudioside A, rebaudioside B, rebaudioside C, rebaudioside D, rebaudioside M, iso-steviol glycosides, mogrosides, trilobatin, and combinations thereof. In some embodiments, the non-nutritive sweetener is rebaudioside A (Reb A), rebaudioside D (Reb D), rebaudioside M (Reb M), or any combination thereof (e.g., a mixture of Reb A and Reb D, a mixture of Reb D and Reb M, or a mixture of Reb A, Reb D, and Reb M). In some embodiments, the non-nutritive sweetener is stevia leaf blend. In some embodiments, the plant-based chocolate comprises an artificial sweetener such as aspartame, sucralose, acesulfame potassium (ASK), or any combination thereof. In some embodiments, the sweetening component comprises a combination of stevia extract and sucrose.

In some embodiments, the plant-based chocolate can further include a supplemental sweetness enhancer. Suitable supplemental sweetness enhancers are described herein. In some embodiments, the supplemental sweetness enhancer is D-psicose, erythritol, or a combination thereof.

Referring back to FIG. 1, in some embodiments once the sesame component 4 and sweetening component 5 are mixed into a homogeneous composition 8, cacao powder 6 can also be added. In some embodiments, the cacao powder 6 comprises between about 5% to about 40% of overall weight of the homogeneous composition 8. The cacao powder average percent weight to overall product weight can vary based on desired finished product physical and sensory attributes, as well as percent weight of other dry components, fats, oils, liquids or any combination thereof added to the product. For example, dark chocolate will incorporate higher percent of cacao powder than crème gold chocolate. In some embodiments, the cacao powder 6 comprises about 7%. In some embodiments, the cacao powder 6 comprises about 10%. All percentages in this paragraph refer to cacao powder percent weight to overall product weight.

Referring back to FIG. 1, in some embodiments, once a homogeneous composition 8 is created after mixing in the sesame component 4, or a sesame component in addition to an admixture of a sweetening component 5 and/or a cacao component; other components 7 may also be added to the homogeneous composition 8. For example, in some embodiments, scraped vanilla beans can be added to the homogeneous composition 8. In some embodiments, vanilla bean extract can be added to the homogeneous composition 8. In some embodiments, milk powder can be added to the homogeneous composition 8. In some embodiments, adding liquid vanilla extract or other liquids can cause sudden increase in velocity of the homogeneous mix, in such a case; the addition of sesame paste reduces velocity without affecting desired outcome. In some embodiments, a sesame component comprising sesame paste can be added to the homogeneous composition of high velocity. In some embodiments, the sesame component comprising sesame paste added to the homogeneous composition of high velocity comprises between about 1% to about 5% by weight of overall weight of the homogeneous composition 8. In some embodiments, a sesame component comprising sesame paste is added to the homogeneous composition 8 to make crème gold chocolate ganache, wherein the sesame paste comprises about 40% to 55% by weight of overall product weight.

Referring back to FIG. 1, once a homogeneous composition 8 is achieved, the homogeneous composition 8 is poured into molds 9 and cooled 10 at room temperature. In some embodiments, the cooling step 10 comprises cooling the molded composition at temperatures between about 50.degrees.F. to about 68.degrees.F. In some embodiments, the cooling step 10 comprises cooling the molded composition at temperatures between about 60.degrees.F. to about 65.degrees.F. In some embodiments, the cooling step 10 comprises cooling the molded composition for at least 30 minutes until the chocolate is hardened 11 completely or partially.

Referring back to FIG. 1, once the cooled chocolate is hardened 11, a reheating 12 of the hardened chocolate 11 takes place, once the hardened chocolate is completely melted 13, the molten chocolate 13 goes under a supercooling 14 process, after which, the supercooled molten chocolate is placed in molds 15 and cooled 16.

In some embodiments, reheating 12 the hardened chocolate 11 comprises reheating the chocolate using indirect heat. In some embodiments, reheating 12 the hardened chocolate 11 comprises reheating the chocolate at temperatures between about 99.degrees.F. to about 116.degrees.F. In some embodiments, reheating 12 the hardened chocolate 11 comprises reheating between about 70% to about 90% of the hardened chocolate 11. In some embodiments, the supercooling 14 comprises gradually cooling the molten chocolate 13 by increments between about 1 to about 5 degrees/min. In some embodiments, the supercooling 14 comprises gradually cooling the molten chocolate 13 to a temperature between about 86.degrees.F. to about 88.degrees.F. In some embodiments, the supercooling 14 comprises rapidly adding between about 10% to about 30% of the hardened chocolate 11, constantly stirring the composition until all hardened chocolate is melted.

In some embodiments, a flavor component may be added before or after the supercooling step 14. By way of example, a flavor, flavoring, or flavorant may include solid or liquid flavorants, and the like, used to deliver flavor, taste, seasoning or aroma, including without limitation a citrus flavoring, herbs, spices, coffee, and combinations thereof. In certain embodiments, the chocolate disclosed herein can contain a flavor composition, for example, natural, nature identical, and/or synthetic fruit flavors, botanical flavors, other flavors, and mixtures thereof. As used herein, the term “fruit flavor” refers generally to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

In some embodiments, a food component may be added after supercooling step 14 for flavoring purposes, including without limitation fruits and dried fruits, treenuts, peanuts, cookies, seeds, pudding, etc.

Referring back to FIG. 1, once the molten chocolate 13 is supercooled 14 to a desired temperature, the supercooled molten chocolate is poured into molds 15 and cooled 16 at room temperature. In some embodiments, the cooling step 16 comprises cooling the molded molten chocolate at temperatures between about 50.degrees.F. to about 68.degrees.F. In some embodiments, the cooling step 16 comprises cooling the molded molten chocolate at temperatures between about 60.degrees.F. to about 65.degrees.F. In some embodiments, the cooling step 10 comprises cooling the molded composition for at least 30 minutes until the chocolate is hardened completely.

The plant-based chocolate compositions described herein are plant-based and free from additives, preservatives and the 8 main food allergens namely dairy, eggs, tree-nuts, peanuts, glutin, soy, fish and shellfish. In some embodiments, the chocolate compositions are free from nuts, peanuts, almonds, and/or cashews. In some embodiments, the compositions are also free from soy and/or coconut. In some embodiments, the chocolate compositions are free from dairy. In some embodiments, the compositions are also free from gluten. In some embodiments, the compositions are free from corn.

The prototypes of the plant-based chocolate comprising a sesame component produced using the methods described herein comprise creamy mouthfeel and a great balance of flavor and sweetness levels, with a perfect snap and melting point right below body temperature and a long shelf life. The sensory and physical characteristics of the prototypes resemble and even improve the characteristics of dairy-based milk and white chocolate. The prototypes of the plant-based chocolate comprising a sesame component produced using the methods described herein have an observed crystallization of polymorphic form V.

Surprisingly, and advantageously, the crystallization behavior of cacao butter with a weighed mixture of a sesame component resulted in crystallization of Polymorphic form V with melting point between about 88.degrees.F. to about 93.degrees.F.

The addition of a sesame component (in both its solid and paste forms) also resulted in lower observed viscosity of the chocolate mixture at different melting points, as such the sesame component acted as a natural emulsifier eliminating the need for additives like soy lecithin.

Further, the resulting tempered chocolate were stored at varying high and low temperatures for several weeks to expedite the occurrence of fat bloom, however; no bloom was observed after 6 weeks. Which indicates the sesame component acted as a natural chocolate preservative delaying fat bloom.

Sesame seed is a reservoir of nutritional components with numerous beneficial effects along with health promotion in humans. The bioactive components present in the seed include vital minerals including calcium, magnesium, copper, phosphorus and potassium; as well as vitamins, phytosterols, polyunsaturated fatty acids, tocopherols and unique class of lignans antioxidants such as sesamin and sesamolin. Which enhances the nutritional value of the chocolate, overcoming some of the less desirable attributes in dairy-based milk and white chocolate.

As understood by those skilled in the art, the chocolate in accordance with the disclosure herein can also include various other ingredients. In certain embodiments, preservatives can be added if desired or necessary, depending upon factors including the presence of other ingredients, production technique, desired shelf life, etc. In some embodiments, tree-nut and coconut can be added. In some embodiments, milk powder can be added.

It should be understood that plant-based chocolates in accordance with this disclosure can have any of numerous different specific formulations or constitutions. The formulation of a chocolate product in accordance with this disclosure can vary, depending upon such factors as the product's intended market segment, its desired nutritional characteristics, flavor profile, and the like.

The formulations and compositions described herein are now further detailed with reference to the following examples. These examples are provided for the purpose of illustration only and the embodiments described herein should in no way be construed as being limited to these examples. Rather, the embodiments should be construed to encompass any and all variations, which become evident as a result of the teaching provided herein.

### Example 1—the Process of Making and Tempering a Gourmet Plant-Based “Crème Blanche” Chocolate of Polymorph V

A sesame component characterized by a macronutrient composition of 3:2 protein to fat ratio by weight and a bulk density of 0.17±0.03 g/ml was obtained by means of sesame protein flour. A cacao component comprising cacao butter was heated at about 118.degrees.F. until it was completely melted. The melted cacao butter was supercooled by gradually mixing in solid compounds of the sesame component and powdered cane sugar until a homogeneous compound was created at a temperature of about 95.degrees.F. The overall composition comprised about 45% cacao butter, 35% powdered sugar, and 18% sesame component. The composition was poured into small cavity silicon molds with cavities of about 1 sq cm in size and cooled between about 60.degrees.F. to about 65.degrees.F. for at least an hour. After which the chocolate was removed from the molds and 80% of it was heated between about 113.degrees.F. to about 118.degrees.F until completely melted. Scraped vanilla bean was added to the molten chocolate comprising 0.2% of overall weight of the molten chocolate, and the molten chocolate was then supercooled by adding the remaining 20% hard chocolates to the composition, constantly stirring the composition until all chocolate was melted and a temperature between about 86.degrees.F. to about 89.degrees.F was reached. The molten chocolate was poured into molds and cooled between about 60.degrees.F to about 65.degrees.F.

### Example 2—the Process of Making and Tempering a Gourmet Plant-Based “Crème Gold” Chocolate at Polymorph V

A sesame component characterized by a macronutrient composition of 3:2 protein to fat ratio by weight and a bulk density of 0.17±0.03 g/ml was obtained by means of sesame protein flour. A cacao component comprising cacao butter was heated at about 118.degrees.F. until it was completely melted. The melted cacao butter was supercooled by gradually mixing in solid compounds of the sesame component, powdered cane sugar and cacao powder until a homogeneous compound was created at a temperature of about 95.degrees.F. The overall composition comprised about 45% cacao butter, 35% powdered sugar, 10% cacao powder and 8% sesame component. The composition was poured into small cavity silicon molds with cavities of about 1 sq cm in size and cooled between about 60.degrees.F. to about 65.degrees.F. for at least an hour. After which the chocolate was removed from the molds and 80% of it was heated between about 113.degrees.F. to about 118.degrees.F. until completely melted. The molten chocolate was then supercooled by adding the remaining 20% hard chocolates to the mix, constantly stirring the composition until all chocolate was melted and a temperature between about 86.degrees.F. to about 89.degrees.F. was reached. The molten chocolate was poured into molds and cooled between about 60.degrees.F. to about 65.degrees.F.

### Example 3—the Process of Making “Créme Gold” Chocolate Ganache

A sesame component characterized by a macronutrient composition of 2:4 protein to fat ratio by weight, was obtained by means of corresponding proportions of sesame paste and sesame protein, wherein the sesame protein to sesame paste ratio was about 1:15 by weight. A cacao component comprising cacao butter was heated at about 118.degrees.F. until it was completely melted. The melted cacao butter was supercooled by gradually mixing in solid compounds of the sesame component, powdered cane sugar and cacao powder until a homogeneous compound was created at a temperature of about 95.degrees.F. The composition was poured into small cavity silicon molds with cavities of about 1 sq cm in size and cooled between about 60.degrees.F. to about 65.degrees.F. for at least an hour. After which the hardened chocolate was removed from the molds and heated between about 113.degrees.F. to about 118.degrees.F. until completely melted. After the chocolate is melted, temperature was reduced to about 95.degrees.F., when the composition reached that temperature the liquid part of the sesame component (i.e. sesame paste) was mixed in until a homogeneous composition was achieved, further agave nectar was mixed in until a homogeneous composition was achieved. The composition was poured into molds and cooled between about 60.degrees.F. to about 65.degrees.F. for at least 30 minutes. The overall composition comprised about 15% cacao butter, 35% sweetener (of which 15% powdered sugar and 20% agave nectar), 8% cacao powder and 42% sesame component.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, it should be understood that the method steps described herein are exemplary, and upon reading the present disclosure, a skilled person would understand that one or more method steps described herein can be combined, omitted, re-ordered, or substituted.

As used herein, examples of “about” and “approximately” include a specified value or characteristic to within plus or minus 15, 10, 5, 4, 3, 2, or 1% of the specified value or characteristic. As used herein, examples using the term “between” include end points. For example, a range between 1 and 5 include 1 and 5 along with all other values greater than 1 and less than 5.

While this invention has been particularly shown and described with reference to preferred embodiments, it will be understood by those skilled in the art that various changes in form and detail may be made therein without departing from the spirit and scope of the invention. The inventor expects skilled artisans to employ such variations as appropriate, and the inventor intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A plant-based chocolate, comprising:
A sesame component including sesame flour, sesame protein, sesame paste or any combination thereof; and
A cacao component including cacao butter, cacao liquor or any combination thereof.

2. The plant-based chocolate of claim 1, wherein the sesame component characterized by a macronutrient composition having average protein to fat ratio of about 3:2 by weight.

3. The plant-based chocolate of claim 1, wherein the sesame component characterized by a macronutrient composition having average protein to fat ratio of about 2:4 by weight.

4. The plant-based chocolate of claim 1, wherein the bulk density of the solid part of the sesame component is between about 0.1 g/ml to about 0.3 g/ml.

5. The plant-based chocolate of claim 1, wherein the sesame component average percent weight to overall product weight comprises from about 5% to about 80%.

6. The plant-based chocolate of claim 1, wherein the cacao component average percent weight to overall product weight comprises from about 10% to about 95%.

7. The plant-based chocolate of claim 1, wherein the sesame component acts as a preservative delaying fat bloom.

8. A method for making and tempering chocolate comprising a sesame component to a desired polymorphic phase. The method includes:
Heating a cacao component until completely melted;
Supercooling the cacao component by gradually combining a sesame component;
Constantly mixing the combination until a homogeneous composition is achieved;
placing the combination with the sesame component in a mold;
cooling the combination until hardened;
Partially re-heating the hardened combination until completely melted;
Supercooling the heated combination,
placing the combination in a mold; and
cooling the combination.

9. The method of claim 8, wherein heating (1) includes heating the combination between about 100.degrees.F. to about 120.degrees.F.

10. The method of claim 8, wherein supercooling (3) includes gradually cooling the combination by increments between about 0.5 to about 2 degrees/min to a temperature between about 93.degrees.F. to about 100.degrees.F.

11. The method of claim 8, wherein reheating (12) includes reheating the combination to a temperature between about 99.degrees.F. to about 116.degrees.F.

12. The method of claim 8, wherein supercooling (14) includes gradually cooling the combination by increments between about 1 to 5 degrees/min to a temperature between about 86.degrees.F. to about 88.degrees.F

13. The method of claim 8, wherein cooling (10) (16) includes cooling the combination between about 50.degrees.F. to about 68.degrees.F.

14. The method of claim 8, wherein the sesame component acts as an emulsifier.

15. The method of claim 8, wherein one or more components can be added in addition to the sesame component during the supercooling step (3), including but not limited to cacao powder and a sweetener.

16. The method of claim 8, wherein one or more flavoring components can be added to the plant-based chocolate with the sesame component before or after supercooling step (14), including but not limited to flavoring extracts, spices, coffee, dried fruits, nuts, coconut, cookies.
